(19) United States
(12) Patent Application Publication
(10) Pub. No.: US 2025/0189276 A1
(43) Pub. Date: Jun. 12, 2025

(54) CONSTRUCTION ELEMENT FOR A SAFETY CABINET, A DOOR FOR A CONTAINER AND A CONTAINER COMPRISING SUCH A CONSTRUCTION ELEMENT AND A METHOD FOR IMPROVING A SAFETY CABINET

(71) Applicant: CESIUM HOLDING AB, SE-641 39 Katrineholm (SE)

(72) Inventor: Jack GUSTAVSSON, Katrineholm (SE)

(73) Assignee: CESIUM HOLDING AB, SE-641 39 Katrineholm (SE)

(21) Appl. No.: 18/845,696

(22) PCT Filed: Jan. 31, 2023
(86) PCT No.: PCT/SE2023/050082

§ 371 Date: Sep. 10, 2024

(30) Foreign Application Priority Data
Mar. 16, 2022 (SE) 2230075-0

(51) Int. Cl. F41H 5/02; A47B 55/04

(52) U.S. Cl. CPC F41H 5/02; A47B 55/04

(57) ABSTRACT

A construction element includes concrete and a first wall, where the first wall is made out of armor plate and arranged with at least one anchor. A method for improving the security of a safety cabinet is also provided.

### BACKGROUND AND SUMMARY

The present invention relates to a construction element comprising concrete and a first wall, where the first wall is made out of armor plate and arranged with at least one anchor. The invention further relates to a method for improving a safety cabinet.

Safe and secure storage of valuable materials, products or property is important in order to prevent access by unauthorized or unqualified persons or as protection against burglary and theft. Other reasons for storing content in a controlled environment may include protecting content from being damaged during a flood, fire or natural disaster.

Access to items such as weapons, certain medical and/or chemical products and/or explosives must be prevented by law in many different locations/jurisdictions. Furthermore, entry/access can be regulated/controlled with a basis in insurance purposes.

It is common practice to use a safe for storing valuable items, and the security level is usually tested by a certification company or a certification organization such as UL, TÜV or RISE (formerly the SP Technical Research Institute of Sweden) in accordance with a specific standard, such as EN 1143-1. Safes, or locks to a safe, are typically graded as to their specific level of protection. Safes that are awarded a high grade as to their level of protection require a long time and considerable power to force open.

An example of a structure or structural element for a safety cabinet is shown in patent document EP 0078566. The patent document shows systems to prevent forcing with the help of diamond drills by means of arranging special structures in concrete. The patent document shows a complex solution to prevent forcing with the help of diamond drills and does not show a method to improve existing structures against diamond drilling.

It is desirable to provide a new and improved construction element for a safety cabinet and a method for improving a construction element for a safety cabinet.

The invention relates, according to an aspect thereof, to a construction element

comprising concrete and a first wall, characterized in that the first wall is made out of armor plate and arranged with at least one anchor.

According to further aspects of the improved structural element, the structural element further comprises:
the armor plate having a hardness in the range of 480-540 HBW.
that the anchor(s) is/are arranged with at least one through hole.
that the surface of the first wall is arranged with a number of anchors arranged in a grid pattern with a distance between each anchor in the range 8 cm-18 cm.
that a second wall, a first side wall and a second side wall have been arranged against the first wall to jointly form a mold for the pouring of concrete and to hold the concrete once the concrete has been poured.
that the concrete includes at least one additive selected from wood pellets, plastic pellets and/or metal pellets.

Additionally, the invention relates, according to an aspect thereof, to an improved door comprising a structural element, at least one lock and at least one hinge.

Additionally, the invention relates, according to an aspect thereof, to an improved container comprising at least one structural element and one door.

Additionally, the invention relates, according to an aspect thereof, to a method for improving a safety cabinet with a concrete wall for better resilience against diamond drilling where the following method steps are included;
arranging armor plate on the inside of the safety cabinet,
arranging at least one hole in armor plate, going into a concrete wall,
arranging fastening elements in holes so that armor plate is arranged to the concrete.

According to further aspects of the method of improving a concrete wall safe further comprise:
fastener arranged in holes being arranged with an interval of 8 cm-18 cm from one another in a grid.

Advantages of the present invention include improving the safety of safety cabinets. These improvements especially concern resistance to drilling with diamond drills, especially when it comes to core drills. Furthermore, the invention results in improvements to the electromagnetic shielding in safety cabinets.

### BRIEF DESCRIPTION OF THE DRAWINGS

The invention will be described below by reference to the figures that are included there:

FIG. 1 shows a figure of a structural element in accordance with an embodiment of the invention.

FIG. 2 shows a figure of a structural element in accordance with an alternative embodiment of the invention.

FIG. 3 shows an anchor according to an embodiment of the invention.

FIG. 4 shows an anchor arranged on a plate in accordance with one embodiment of the invention.

5 shows a figure of a container in accordance with one embodiment of the invention.

FIG. 6 shows the frame for a container in accordance with one embodiment of the invention.

### DETAILED DESCRIPTION

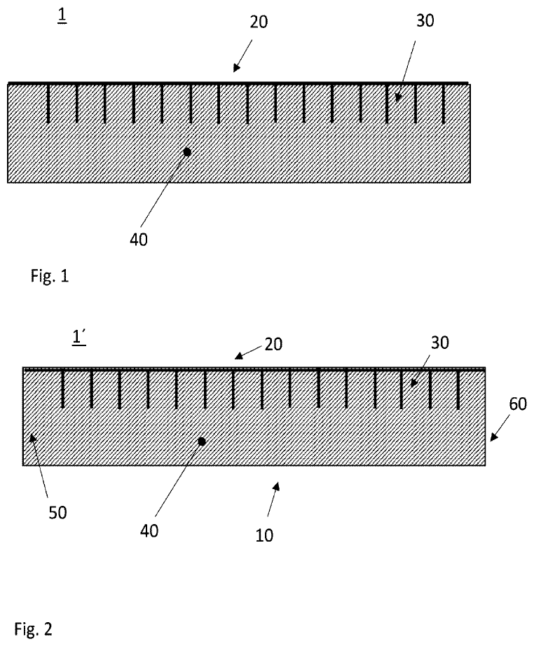

FIG. 1 shows a figure of a structural element 1 in accordance with one embodiment of the invention The construction element is preferably a wall element, a door element, a lower element, or an upper element in a safety cabinet. For instance, a safe can be a container, also known as an intermodal container, which is used to coordinate cargo and goods into a larger, unified, load that can be easily handled, moved, and stacked, and which can be loaded onto a ship or a storage location in a tight fashion. Intermodal containers are designed so that they are compatible with various types of transportation, meaning that the transported goods do not require repackaging during transportation. Reloading may result in an increased risk of theft or damage to the goods in the container.

Intermodal containers share several key design features to withstand the stresses of transportation, to facilitate their handling and to enable them to be stacked, and are identifiable by their individual unique report markings, in accordance with ISO 6346.

Container lengths can be between 8 and 56 feet (2.4 m and 17.1 m). Ordinarily, containers are twenty feet (6.1 m) or forty feet (12.2 m) in length and are preferably rectangular, closed box models with doors mounted at one end, and made out of corrugated stainless steel (also called Corten steel) with plywood floors. Corrugation of the sheet metal used for the sides and roof contributes significantly to the container's rigidity and stacking strength.

Standard containers are either 8 feet (2.44 m) wide and 8 feet 6 inches (2,59 m) high or taller “High Cube” or “hi-cube” units which are 9 feet 6 inches (2.90 m).

ISO containers are provided with turnstile fastener openings at each of the eight corners, to allow connection from above, below or from the side, and they can be stacked up to ten units high. Container capacity is most often expressed in twenty-foot equivalent units (TEU, or sometimes teu).

According to FIG. 1, a structural element 1 comprises a first wall element 20. The first wall element 20 is made out of armor plate in order to further increase the resistance of the structural elements 1 against external forces.

Armor plate must be hard, yet resistant to impact, in order to be able to withstand high-velocity metal projectiles. Steel with these properties is produced by machining cast steel blanks of the appropriate size and then rolling them into plates of the required thickness. Hot rolling homogenizes the coarse grain of the steel, which eliminates imperfections that would otherwise reduce the strength of the steel. Rolling also stretches out the coarseness of the steel and thus forms long lines that distribute the load on the steel throughout the metal, whereby it becomes possible to prevent the load to be concentrated in one single area. This type of steel is termed rolled homogeneous armor or RHA. RHA is homogeneous due to its structure and composition being uniform throughout the entirety of its thickness. The opposite of homogeneous steel plate is cemented or surface-hardened steel plate, where the surface of the steel has been designed in a different way than the substrate. The surface of the steel has been hardened through a heat treatment process. Hardness of the armor plate is preferably in the range 480-540 HBW. Where HBW is defined according to the standard EN ISO 6506-1:2014.

The construction element 1 comprises at least three elements, a first wall element 20, concrete 40 and anchor 30. In the event of an attempt to force the structural element 1, the work of penetrating the concrete 40 begins. Concrete is preferably penetrated by drilling and/or sawing or some other form of cutting operation.

When the concrete has been penetrated, the first wall 20 must be penetrated. A diamond drill is arranged so as to be able to penetrate concrete, but when the armor plate in the first wall 20 is reached, the diamond drill will not be able to penetrate the wall. Preferably, diamond drills in the form of a core drill are to be used. A core drill is a cylindrical drill with a hole in the center specially adapted to drill larger holes. When the drill reaches the first wall 20, the diamond drill will not be able to penetrate the wall 20, thus necessitating an alternative form of processing. In order to reach the first wall 20, the concrete core that has been created in the core drill must be removed, but when anchors are placed above the surface, the concrete core will be retained by at least one anchor, whereas at least one anchor will be arranged in the drill core depending on the location of the anchor, which makes it impossible to remove the concrete core. The distribution of anchors is thus such that at least one anchor will be arranged in the drill core.

The construction element 1 is filled with concrete 40, i.e. a composite consisting of or comprising at least cement and ballast. Ballast consists of or comprises fine-particle material ranging from coarse to medium grain size, including sand, gravel, crushed stone, slag, recycled concrete and/or other material.

The concrete can also include one additive selected from wood pellets, plastic pellets and/or metal pellets. Concrete admixtures with a low density serve to reduce the total weight of structural element 1. Concrete admixtures with high density increase the overall weight but are an option for providing the concrete with desirable properties, such as increased resistance to cutting or other processing. A manufacturing method includes arranging the first wall 20, with anchor 30, and a reinforcement bar being arranged horizontally in a form, whereupon concrete is arranged on the first wall 20 and whereby anchor 30 is arranged in the concrete. Furthermore, steel wire can be arranged in combination with a reinforcement bar in order to further increase resistance to penetration of the concrete.

The technical solution aims to make penetration of the structural element as complicated and time-consuming as possible. If the structural element is penetrated for a longer time, this entails an increased risk of detection.

According to FIG. 2, which shows an alternative embodiment, a construction element 1′ comprises a second wall element 10 and a first wall element 20. The wall elements 10, 20 are preferably manufactured out of steel, and the wall elements for containers are typically made out of corrugated steel. The reason why corrugated steel is used is mainly to increase the rigidity of the container and thus allow stacking of containers.

For a container that utilizes the described structural element 1′ there is no specific need to use corrugated walls, since the rigidity of the containers is increased by the described structural element 1′ construction. However, corrugated wall elements can be used in the described structural element 1′ to further increase the rigidity, or in order for a container that has been manufactured with the described structural element 1′ to give the visual impression of being a normal container.

The material used in the second wall element 10 is usually Corten steel or some other material with increased resistance to corrosion in comparison with ordinary steel.

The construction element 1 comprises at least four steel walls, 10, 20, concrete 40 and anchor 30. In the event of an attempt to force the structural element 1′, the second wall element 10 will be the first surface that must be forced. To penetrate the steel wall 10, a gas burner or blowtorch or other heat-generating means may be utilized. Once the second wall element 10 has been penetrated, the next step is penetrating the concrete 40. Concrete is preferably penetrated by drilling and/or sawing or some other form of cutting operation.

When the concrete has been penetrated, the first wall 20 must be penetrated. A diamond drill is arranged so as to be able to penetrate concrete, but when the armor plate in wall 20 is reached, the diamond drill will not be able to penetrate the wall. Preferably, diamond drills in the form of a core drill are to be used. A core drill is a cylindrical drill with a hole in the center specially adapted to drill larger holes. When the drill reaches the first wall 20, the diamond drill will not be able to penetrate the first wall 20, thus necessitating an alternative form of processing. In order to reach the first wall 20, the concrete core that has been created in the core drill must then be removed, but when anchors are placed above the surface, the concrete core will be retained by at least one anchor, whereas at least one anchor will be arranged in the drill core depending on the location of the anchor, which makes it impossible to remove the concrete core.

In one embodiment, a first side wall 50 and a second side wall 60 have been arranged at the lateral ends of the second wall 10 and the first wall 20, to form a mold or a shaped space in which space reinforcement iron or reinforcement bars are arranged. The concrete 40 is poured into the void formed by the four wall elements, the first side wall 50, the second side wall 60, the second wall 10 and the first wall 20. The thickness of the construction element 1′ is preferably between 100 mm and 300 mm.

The technical solution aims to make penetration of the structural element as complicated and time-consuming as possible. If the structural element is penetrated for a longer time, this entails an increased risk of detection.

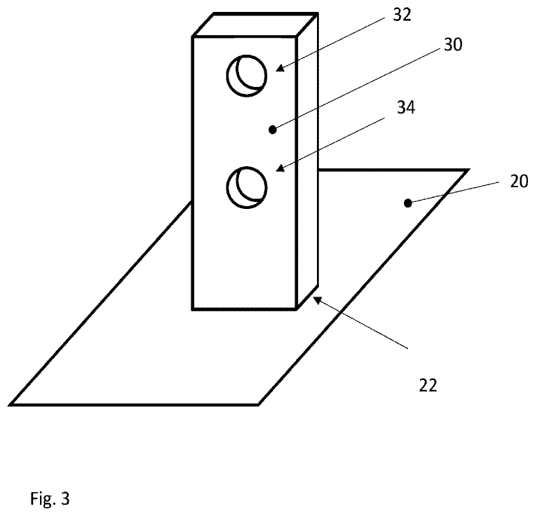

FIG. 3 shows an embodiment of an anchor 30 arranged on the first wall 20 preferably by means of welding with a welding joint 22. The anchor 30 is arranged with at least one hole 32, 34 or other through hole in which concrete 40 can be arranged when casting structural element 1 in order to fix the anchor 30 to the concrete 40. In an alternative embodiment, anchors can be arranged by arranging the first wall 20 with screws or other connections, for example by drilling a hole through the first wall 20 and into the concrete 40 in the construction element 1, 1′, after which a screw/bolt can be arranged in the hole to create a connection between the concrete 40 and wall 20.

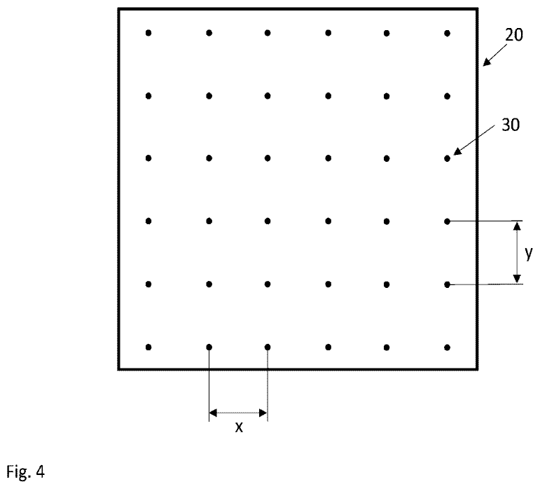

FIG. 4 shows an embodiment with anchors 30 arranged on the first wall 20 in the form of a matrix and/or grid pattern. In the figure, 36 anchors are arranged with a distance x and y respectively between the respective anchors. The space, or distance, x is preferably in the range 8 cm-18 cm and the distance, or distance, y is preferably in the range 8 cm-18 cm. Similarly, fasteners can be arranged placed in a matrix and/or grid pattern by drilling holes in an armor plate as well as in concrete and arranging fasteners in the holes. Fasteners can also be arranged in the form of an expander plug or the like in order to retain the fasteners in the concrete/armor plate.

FIG. 5 shows a container 100. A container 100 in a typical embodiment has an upper element, a lower element and four wall elements and at least one door. In traditional shipping containers, the doors are usually a two-part construction that has been arranged in one of the side walls. In a safety container, a single door is preferred. The container shown in FIG. 5 comprises a first wall element 102, a second wall element 104 and a third wall element 106. The container further includes a door element 108 arranged in a frame 200 which holds the door element 108 in place. The door element 108 has preferably been arranged with a lock, not shown in FIG. 5, arranged behind a lock protection screen 110. The container 100 further includes an upper element 112 and a lower element 114.

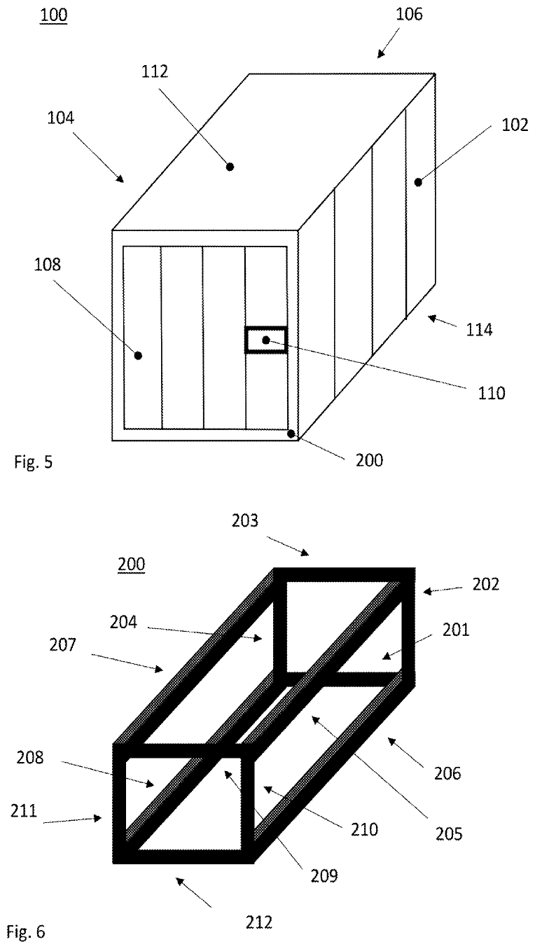

FIG. 6 shows the frame 200 for a container. The frame has a shape where the bars extend along the edges of an imaginary cube and it is preferably made out of steel, concrete or another material of sufficient strength. The frame 200 is preferably made out of twelve bars 201, 202, 203, 204, 205, 206, 207, 208, 209, 210, 211, 212 arranged so as to form a frame 200. In a container 100, a number of structural elements 1, 1′ are arranged, preferably an upper element 112, a lower element 114 and three wall elements 102, 104, 106 as well as at least one door element 108, in a frame 200. The construction elements 1, 1′ have been secured to the frame 200 with fasteners such as bolts, rivets or other fasteners. Holders for the door element 108 consist of or comprise hinges arranged in the frame 200. The hinges are not shown in the drawings, but any form that they take on is well known to those skilled in the art. Said hinges are arranged so as to prevent the door member 108 from being lifted off the hinges. By galvanically/electrically connecting the respective structural elements, which are arranged with an electrically conductive interior, the container is also able to function as electrical shielding.

The invention is not limited to the embodiments specifically shown, but can be varied in different ways within the framework of the claims.

For instance, it is understood that the size, material and how the components of the construction element are arranged as well as the constituent elements and details are adapted to the user's and/or customer's needs for the construction element and to other construction characteristics that apply to the individual case.

1. A construction element for a safety cabinet comprising a first wall made out of armor plate and arranged with at least one anchor, where the anchor is arranged with at least one through hole.

2. The construction element according to claim 1, wherein the armor plate has a hardness in the range of 480-540 HBW.

3. The construction element according to claim 1, wherein a surface of the first wall is arranged with a number of anchors arranged in a grid pattern with a distance between each respective anchor within the range 8 cm-18 cm.

4. The construction element according to claim 1, comprising a second wall, a first side wall and a second side wall arranged against the first wall so as to jointly form a mold for pouring of concrete and to hold the concrete once the concrete has been poured.

5. The construction element according to claim 1, wherein the concrete comprises at least one additive selected from wood pellets, plastic pellets and/or metal pellets.

6. A door for a container comprising a construction element according to claim 1, at least one lock and at least one hinge.

7. A container comprising at least one construction element according to claim 1, and a door comprising at least one lock and at least one hinge.

8. Method for improving a safety cabinet with a concrete wall in order to be more resilient against diamond drilling, comprising
i.) arranging armor plate on an inside of the safety cabinet,
ii.) arranging at least one hole in armor plate, going into a concrete wall,
ii.) arranging fasteners in holes so that the armor plate is arranged to the concrete.
